(19) United States
(12) Patent Application Publication
(10) Pub. No.: US 2013/0041935 A1
(43) Pub. Date: Feb. 14, 2013

(54) EXPEDITING THE DISTRIBUTION OF DATA FILES BETWEEN A SERVER AND A SET OF CLIENTS

(71) Applicants: Adiseshu Hari, Holmdel, NJ (US); Dimitrios Stiliadis, San Jose, CA (US); Andrea Francini, Mooresville, NC (US); Chandra Sekhar, Andhra Pradesh (IN)

(72) Inventors: Adiseshu Hari, Holmdel, NJ (US); Dimitrios Stiliadis, San Jose, CA (US); Andrea Francini, Mooresville, NC (US); Chandra Sekhar, Andhra Pradesh (IN)

(21) Appl. No.: 13/510,311

(22) PCT Filed: Nov. 19, 2010
(86) PCT No.: PCT/EP2010/067856

§ 371 Date: Oct. 25, 2012

(30) Foreign Application Priority Data
Nov. 20, 2009 (IN) 2867CHE2009

(51) Int. Cl. G06F 15/16

(52) U.S. Cl. 709/203

(57) ABSTRACT

Expediting the distribution of data files between a server and a set of clients. The present invention relates to client-server systems and, more particularly, to cache nodes in client-server systems. In a client-server arrangement, a source system transfers data files from the source system to a server cache node connected to the source system. The server cache node sends a list of data files cached in the server cache node to a client cache node. The client cache node sends a request to the server cache node for new data files cached in the server cache node, based on the list received from the server cache node. The server cache node sends the requested data files to the client cache node and the client cache node transfers the data files to a destination system.

### TECHNICAL FIELD

The present invention relates to client-server systems and, more particularly, to cache nodes in client-server systems.

### BACKGROUND

Packet networks enable the exchange of data between remote computing systems. In end computing systems, data are organized, stored, and handled by computing applications as data files. Network elements transfer data files across the network using data blocks called packets. A network path is a sequence of network links between two remote network elements that supports the transfer of data files between those network elements. Many network applications rely on a client-server model, where one server end system (SES) operates as the source of data files for a plurality of client end system (CES) instances.

In typical network settings, the transfer of a data file from an SES to a CES can occur only at times when the following two conditions are simultaneously satisfied: (i) Network Path Integrity (NPI) condition, wherein a working network path exists between the SES and the CES, and (ii) Client End System Availability (CESA) condition, wherein the CES is powered on and capable of operation.

In many cases, the requirement to have both conditions simultaneously satisfied in order to conduct the data-file transfer may lead to inconvenient delays in the delivery of critical data and interfere with the normal operation of the CES, causing dissatisfaction to the CES user and security threats to the organization that uses the network application and relies on the quick distribution of data for its safe operation. Specifically in the case of enterprise information technology (IT) applications, the severity of the security threat grows with the time that elapses between the arrival of a new data file at the SES and the completion of its transfer to the last CES.

Caching is a method broadly used in packet networks to stage the distribution of data files from a server end system to a plurality of client end systems. With caching, a data file is moved from the server to a cache node in the network in a single data-file transfer, independently of the number of clients. If the cache node is properly located along the network paths from the server to the many clients, temporarily storing the data file in the cache node can dramatically reduce the consumption of network resources needed to complete the distribution of the data file to all clients. Traditional caching works well in networks where violations of the NPI and CESA conditions are infrequent, but may be inadequate when deployed in networks where the violations are common. If the cache node does not reside in the portion of network path between the CES and the network segment that most frequently violates the NPI condition, called the sporadic network segment (SNS), then the cache node cannot remove the requirement that both the NPI and the CESA conditions be satisfied at the same time in order for a data file transfer to take place.

### SUMMARY

In view of the foregoing, an embodiment herein provides a method for expediting the transfer of data files between a Server End System (SES) and a plurality of Client End Systems (CES), the method comprising steps of the SES transferring one data file or a plurality of data files from the SES to a Server Cache Node (SCN) connected to the SES; sending a list of data files cached in the server cache node to a plurality of Client Cache Nodes (CCN), wherein each of the plurality of CCNs is connected to each of the plurality of CESs; at least one of the CCNs sending a request to the SCN for data files cached in the SCN, based on the comparison between a list of data files cached in the CCN with the list of the data files cached in the SCN; the SCN sending the requested data files to the CCN that sent the request to the SCN; and the CCN transferring the received data files to the CES. The CCN may be connected to the SCN through a Sporadic Network Segment (SNS). The SCN and plurality of CCNs are in operational state independently of the availability state of the SES, the CES, or the SNS. The method further comprises steps of each of the plurality of CCNs maintaining a list of data files cached in the SCN; and each of the plurality of CCNs requesting the latest version of the list from the SCN at pre-determined intervals of time. The SCN may be connected to the SES by one of a Universal Serial Bus (USB) connection; a Personal Computer Memory Card International Association (PCMCIA) connection; an ExpressCard connection; or a highly available network path. The CCN may be connected to the CES by one of a Universal Serial Bus (USB) connection; a Personal Computer Memory Card International Association (PCMCIA) connection; an ExpressCard connection; or a highly available network path. Each of the plurality of CCNs checks for availability of the CES to which the CCN is connected, before transferring the data files to the CES. Each of the plurality of CCNs further performs steps of storing the data files if the CES to which the CCN is connected is not available and delivering data files to the CES when the CES requests them.

Embodiments further disclose a Server Cache Node (SCN) for expediting the transfer of data files between a Server End System (SES) and a plurality of Client End Systems (CES), the SCN comprising at least one means adapted for caching data files received from the SES, wherein the data files have to be sent to at least one of the CESs; sending a notification to a plurality of Client Cache Nodes (CCNs) when new data files are cached in the SCN, wherein the notification indicates the presence of new data files cached in the SCN; sending a list of data files cached in the SCN to the CCN on receiving a request for the list of data files from the CCN; and sending a data file to the CCN on receiving a request for the data file from the CCN. The SCN is adapted to maintain a list of data files cached in the SCN, wherein the list has details of the data files cached in the SCN and the list is updated when new data files are cached in the SCN. The SCN is adapted to retrieve a list of CCNs in a sleep state; and send a message to each of the CCN instances in a sleep state to bring the CCN instances in a sleep state to an operational state. The SCN may cache the data files in a data storage means. The SCN may be connected to the SES by one of a Universal Serial Bus (USB) connection; a Personal Computer Memory Card International Association (PCMCIA) connection; an ExpressCard connection; or a highly available network path. The SCN may be connected to the plurality of CCNs through a Sporadic Network Segment (SNS). The SCN is in operational state independently of the availability state of the SES or the SNS.

Embodiments herein also disclose a Client Cache Node (CCN) for expediting the transfer of data files between a Server End System (SES) and a Client End System (CES), the CCN comprising at least one means adapted for sending, at pre-determined intervals of time, a request for a latest list of data files to a Server Cache Node (SCN); receiving the list of data files from the SCN; sending a request to the SCN for selected data files cached in the SCN, based on the list of data files; and the CCN transferring the data files to the CES. The CCN may be connected to the SCN through a Sporadic Network Segment (SNS). The CCN may be in operational state independently of the availability state of the CES or the SNS. The CCN is adapted to maintain a list of data files cached in the CCN, wherein the list has details of the data files cached in the CCN and the list is updated when new data files received from the SCN are cached in the CCN. The CCN sends the request to the SCN by comparing the list of data files cached in the SCN with the list of data files cached in the CCN. The CCN caches the data files in a data storage means. The CCN may enter a low-power sleep state when the CES has been not available for a first pre-determined period of time and the CCN has been idle for a second pre-determined period of time, and come back to operational state on receiving a message from the SCN or when the CES becomes available again. The CCN may be connected to the CES by one of a Universal Serial Bus (USB) connection; a Personal Computer Memory Card International Association (PCMCIA) connection; an ExpressCard connection; or a highly available network path. The CCN further stores the data files, and transfers the data files to the CES when the CES requests them.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 illustrates a network with cache nodes between a client end system and a server end system, according to an embodiment herein;

FIG. 2 illustrates a client cache node, according to an embodiment herein;

FIG. 3 illustrates a client cache node dedicated module, according to an embodiment herein;

FIG. 4 illustrates a server cache node, according to an embodiment herein;

FIG. 5 illustrates a server cache node dedicated module, according to an embodiment herein;

FIG. 6 is a flowchart depicting a method for transferring latest data files from an SES to a CES, according to an embodiment herein;

FIGS. 7a and 7b are a flowchart depicting a method of operation of a client cache node, according to an embodiment herein;

FIGS. 8a, 8b and 8c are a flowchart depicting a method of operation of a server cache node, according to an embodiment herein; and

FIG. 9 is a flowchart depicting a method for bringing a client cache node to operational state from a sleep state, according to an embodiment herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

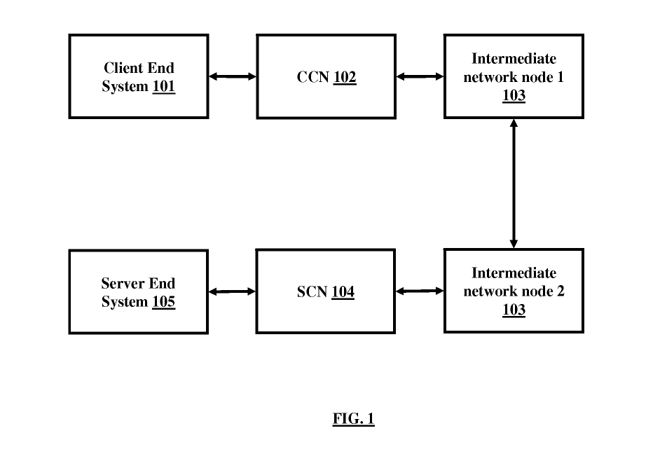

The embodiments herein disclose a method and system for expediting the transfer of data files between a Server End System (SES) and a Client End System (CES) by proactively transferring data files between a Server Cache Node (SCN) and a Client Cache Node (CCN), wherein a highly available network path exists between the SES and the SCN, a highly available network path exists between the CCN and the CES, and a highly available network path may not exist between the SCN and the CCN. The CES then retrieves the transferred data files from the CCN. Referring now to the drawings and more particularly to FIGS. 1 through 9 where similar reference characters denote corresponding features consistently throughout the figures, there are shown embodiments.

FIG. 1 illustrates a network with cache nodes between a client end system and a server end system. A Client End System (CES) 101 in a network initiates data files transfer sessions with a Server End System (SES) 105. The session may be initiated for communicating with the server or for requesting data files from the SES 105. The SES 105 stores data files that can be retrieved by the CES 101 at any point in time. For example, an SES 105 may be a server for enterprise applications and the CES 101 may be allowed access to the data files stored in the SES 105. There may be multiple SES 105 instances and multiple CES 101 instances in the network and a single SES 105 may transfer data files to multiple CESs 101. The SES 105 and the CES 101 may be connected to each other through intermediate network nodes 103. The intermediate network nodes 103 relay data files between the SES 105 and CES 101. There may be a single intermediate network node 103 between the SES 105 and the CES 101 or there may be multiple intermediate network nodes 103 between the SES 105 and the CES 101. Sometimes the network path between the SES 105 and the CES 101 may break due to the sporadic availability of network elements between the SES 105 and the CES 101. Any portion of the network path between the CES 101 and the SES 105 where connectivity disruptions may occur is called a Sporadic Network Segment (SNS). For example, the network link between intermediate network node 1 103 and intermediate network node 2 103 may break leading to the breaking of the network path between the SES 105 and the CES 101. In another example, the CES 101 may be a laptop having wireless connectivity to a wireless network access point that may be connected to the SES 105 through a highly available network path. If the laptop moves away from the wireless network range of the wireless network access point, then the network connection between the CES 101 and the SES 105 is broken. A Server Cache Node (SCN) 104 is a network cache node included in the portion of network path that is common to the network paths between the SES 105 and the CES 105 instances. A Client Cache Node (CCN) 102 is a network cache node included in the network path between the CES 101 and the SNS. The SCN 104 is operational with high availability and has persistent network connectivity with the SES 105. The connection between the SES 105 and the SCN 104 may be a physical connection such as a Universal Serial Bus (USB) connection, a Personal Computer Memory Card International Association (PCMCIA) connection, an ExpressCard connection or any suitable connection means. The connection between the SES 105 and the SCN 104 may also be a network connection with highly available connectivity. The SCN 104 may be placed outside the SES 105 or within the SES 105. The CCN 102 remains in operational state independently of the availability state of the CES 101 and the SES 105. When the CES 101 is in operational state, the CES 101 has persistent connectivity with the CCN 102. The connection between the CES 101 and the CCN 102 may be a physical connection such as a Universal Serial Bus (USB) connection, a Personal Computer Memory Card International Association (PCMCIA) connection, an ExpressCard connection or any suitable connection means. The connection between the CES 101 and the CCN 102 may also be a network connection with highly available connectivity. The CES 101 establishes and continuously maintains connectivity with the CCN 102 every time the CES 101 becomes available and independently of the availability state of the SNS. The network path that connects the SCN 104 and the CCN 102 may include an SNS. When the CCN 102 is in operational state, the CCN 102 establishes connectivity with the SCN 104 when the SNS is available and independently of the availability state of the CES 101. The CCN 102 obtains data files from the SES 105 through the SCN 104, stores the obtained data files and transmits the obtained data files to the CES 101 when the CES 101 requests them. The CCN 102 may be placed outside the CES 101 or within the CES 101. There is at least one CCN 102 instance in the network for each CES 101 instance.

When a CES 101 requires a data file from the SES 105, the CES 101 sends a request for the data file to the CCN 102. The requested data file may be any data file which may be stored in a computing network. If the CCN 102 has the requested data file, the CCN 102 delivers the data file to the CES 101. If the CCN 102 does not have the requested data file, the CCN 102 checks if the SNS connecting the CCN 102 to the SCN 104 is available. If the SNS is available, the CCN 102 forwards the request to the SCN 104 through the SNS. If the data file is present in the SCN 104, the SCN 104 delivers the data file to the CCN 102. If the SCN 104 does not have the requested data file, the SCN 104 forwards the request to the SES 105. On receiving the request, the SES 105 sends the data file to the SCN 104. The SCN 104 then sends the data file to the CCN 102 through the SNS. On receiving the data file from the SCN 104, the CCN 102 checks if the CES 101 is available. The CES 101 may not be available as it may be in a sleep state, or a hibernation state, or in some other state where the CES 101 is not capable of communication. If the CES 101 is available, the CCN 102 transfers the data file to the CES 101. If the CES 101 is not available, the CCN 102 stores the data file, waiting for the next request from the CES 101. When the CCN 102 receives a request from the CES 101 for a data file that the CCN 102 has previously stored, the CCN 102 fetches the data file from the storage means and sends the data file to the CES 101. If the CES 101 has been not available for a pre-determined period of time and the CCN 102 has been idle for a pre-determined period of time, the CCN 102 may enter a low-power sleep state. If there are CCN 102 instances in sleep state, the SCN 104 retrieves the list of CCN 102 instances in the sleep state. When the SCN 104 receives data files from the SES 105 to be sent to a CES 101, the SCN 104 may send a message to the CCN 102 instances that are in sleep state to bring the CCNs 102 to the operational state. For example, the SCN 104 may send a Short Message Service (SMS) to bring the CCN 102 to the operational state. The CCN 102 may also return to operational state when the CCN 102 receives a data packet from the SCN 104.

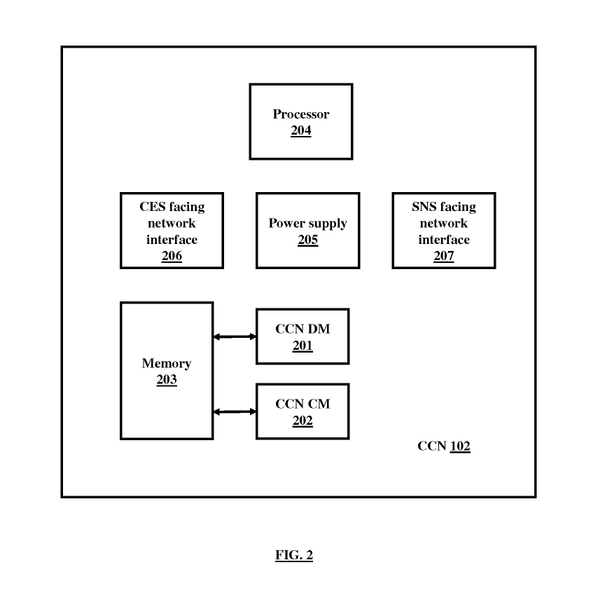

FIG. 2 illustrates a client cache node. A Client Cache Node (CCN) 102 is a network cache node included in the network path between the CES 101 and the SCN 104. The CCN 102 is connected to the SCN 104 through the SNS. The CCN 102 remains in operational state independently of the availability state of the CES 101 and of the SNS. The CCN 102 establishes connectivity with the SCN 104 when the SNS is available and independently of the availability state of the CES 101. The CCN 102 maintains connectivity with the CES 101 every time the CES 101 becomes available and independently of the availability state of the SNS. An independent power supply 205 helps the CCN 102 stay in operational state. The CCN 102 obtains data files from the SES 105 through the SCN 104 via the SNS, stores the obtained data files and transmits the obtained data files to the CES 101. An SNS-facing network interface 207 helps establish a network connection between the CCN 102 and the SCN 104 through the SNS. The CCN 102 obtains data files from the SCN 104 using the SNS-facing network interface 207. The CES-facing network interface 206 helps establish a network connection between the CES 101 and the CCN 102. The data files obtained by the CCN 102 are cached in a memory 203, where the memory 203 may be any suitable data storage means. The memory 203 may be a persistent storage means like a flash drive or a hard disk. When a data file has been sent to the CES 101, the data file is deleted from the memory 203. The data files in the memory 203 are maintained by a CCN Cache Module (CM) 202. The caching of data files and the deletion of data files from the memory 203 is done by the CCN CM 202. A CCN Dedicated Module (DM) 201 maintains a list of the data files cached in the memory 203. The list is maintained as a Data File List (DFL). Each entry in the DFL includes at least a unique identifier for a corresponding data file cached in the memory 203 and an indication of the memory space required by the same data file. For example, the unique identifier may be a uniform resource locator (URL). If new data files file have been cached in the memory 203, the CCN DM 201 updates the DFL. The CCN DM 201 also periodically requests the latest version of the DFL maintained by the SCN 104. When data files are sent from the CCN 102 to the CES 101, the CCN DM 201 arranges for the deletion of the same data files from the memory 203. After the data files have been deleted, the CCN DM 201 marks the entry for the data files in the DFL as “delivered”. The CCN 102 enters a low-power sleep state when the CES 101 is not available for a pre-determined period of time and the CCN 102 has been idle for a pre-determined period of time. When the SCN 104 receives new data files from the SES 105 to be sent to a CES 101 and a new version of the DFL has been created in the SCN 104, the SCN 104 sends a message to the CCNs 102 in sleep state to bring the CCN's 102 in sleep state to the operational state. The message may be an SMS message or any data file. A processor 204 controls the functioning of the CCN 102.

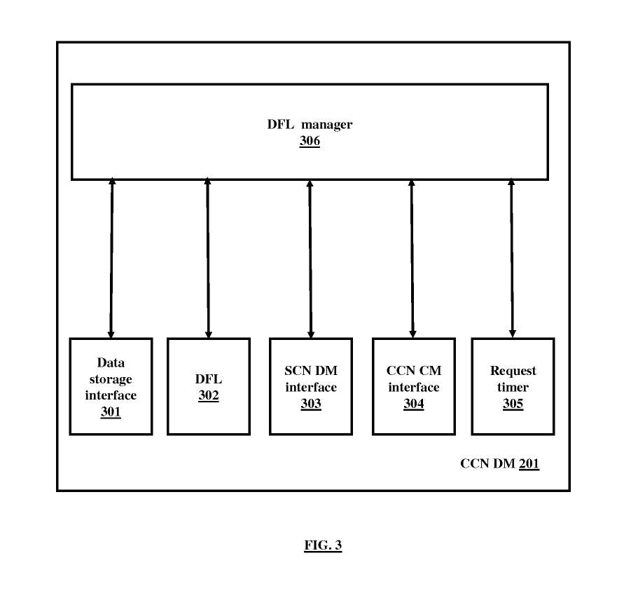

FIG. 3 illustrates a client cache node dedicated module. A CCN Dedicated Module (DM) 201 maintains a list of data files cached in the memory 203, called the Data File List (DFL) 302. Each entry in the DFL 302 includes at least a unique identifier and a size measure for a corresponding data file cached in the memory 203. If new data files have been cached in the memory 203, the CCN DM 201 updates the DFL 302. The CCN DM 201 periodically requests from the SCN 104 the latest version of the DFL maintained by the SCN 104. The periodic requests are sent at pre-determined intervals of time. A request timer 305 defines the periodic time intervals for generating the requests. On receiving the latest version of the DFL from the SCN 104, the CCN DM 201 removes entries listed in the local DFL 302 and not listed in the DFL received from the SCN 104. The CCN DM 201 adds to the local DFL 302 entries listed in the DFL received from the SCN 104 and not listed in the local DFL 302. For example, if the local DFL 302 in the CCN 102 has the entries {F1, F2, F3} and the latest version of the DFL received from the SCN 104 has the entries {F1, F2, F4, F5}, then the CCN DM 201 removes F3 from the local version of the DFL 302 and adds the entries F4 and F5 to the local version of the DFL 302. The updated version of the DFL 302 in the CCN 102 will be {F1, F2, F4, F5}. The CCN DM 201 issues a download request to the CCN CM 202 for every new entry in the DFL received from the SCN 104. When the CCN CM 202 receives the data files download request, if the SNS is available the CCN CM 202 sends a message to the SCN 104 requesting the data files included in the data files download request. After receiving the requested data files from the SCN 104, the CCN 102 sends the data files to the CES 101. After the data files have been sent from the CCN 102 to the CES 101, the CCN DM 201 arranges for the deletion of the data files from the memory 203. After the data files have been deleted, the CCN DM 201 marks the entry for the data files in the DFL 302 as “delivered”. When the CCN DM 201 receives the new version of the DFL from the SCN 104, the CCN DM 201 checks to determine if there is sufficient storage space in the memory 203 to accommodate the new data files. If the storage space is not sufficient to accommodate the new data files, then the CCN DM 201 identifies data files that can be removed from the memory 203. For example, the data file with DFL 302 entry set to “delivered” may be removed from the memory 203. A data storage interface 301 interfaces with the memory 203 and obtains information about the current memory usage. If any data files have to be deleted from the memory 203, the data storage interface 301 removes the data files from the memory 203. An SCN DM interface 303 receives notifications from the SCN 104 indicating the availability of new versions of the DFL 302. On receiving a notification from the SCN 104, the SCN DM interface 303 responds to the notification by requesting the advertised new version of the DFL from the SCN 104. The SCN DM interface 303 also receives the new versions of the DFL from the SCN 104. A Data File List Manager (DFLM) 306 maintains the DFL 302 based on information received from the data storage interface 301 and the SCN DM interface 303. If the DFLM 306 determines that there are new entries in the updated DFL 302, then the DFLM 306 issues a delivery request for obtaining the corresponding data files from the SCN 104. The DFLM 306 sends the delivery request to a CCN CM interface 304. The CCN CM interface 304 relays the delivery request to the CCN CM 202.

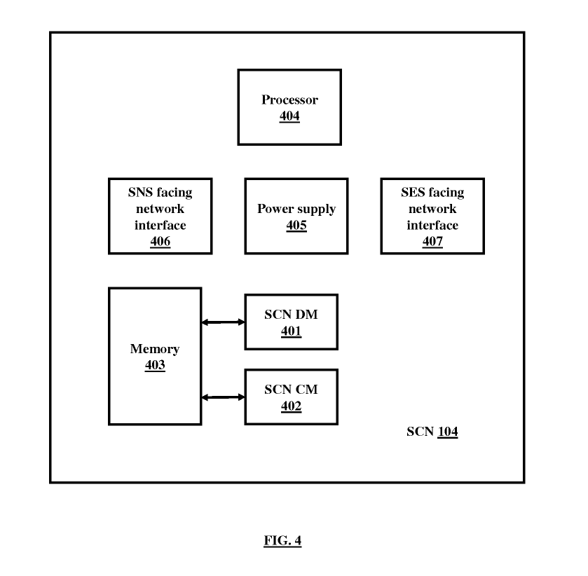

FIG. 4 illustrates a server cache node. An SCN 104 is a network cache node included in the portion of network path to the SES 105 that is common to all CES 101 instances in the network. The SCN 104 is always operational and has persistent network connectivity with the SES 105. The connection between the SES 105 and the SCN 104 may be a physical connection such as a Universal Serial Bus (USB) connection, a Personal Computer Memory Card International Association (PCMCIA) connection, an ExpressCard connection or any suitable connection means. The connection between the SES 105 and the SCN 104 may also be a network connection with highly available connectivity. The SCN 104 obtains data files from the SES 105 and stores them in a memory 403, where the memory 403 may be any suitable data storage means. The memory 403 may be a persistent storage means like a flash drive or a hard disk. An independent power supply 405 enables the SCN 104 to stay in operational state with high availability irrespective of the availability of the CES 101 instances. The SCN 104 is included in the portion of network path to the SES 105 that is common to all CES 101 instances. The SCN 104 obtains data files from the SES 105, stores the obtained data files and transmits the obtained data files to the CCN 102 instances. An SES-facing network interface 407 helps establish a network connection between the SCN 104 and the SES 105. The SCN 104 obtains data files from the SES 105 and sends data files to the SES 105 using the SES facing network interface 407. An SNS-facing network interface 406 helps establish network connections between the SCN 104 and the CCN 102 instances across the respective SNS instances. The SCN 104 obtains data files from the CCN 102 instances and sends data files to the CCN 102 instance using the SNS-facing network interface 406. The data files obtained by the SCN 104 are cached in a memory 403. Not all data files stored in the memory 403 may have corresponding entries in the DFL. The SCN creates entries in the DFL only for data files that originate from a selected set of data file sources. The SCN 104 maintains a list of the data file sources such that DFL entries must be created in association with data files that originate from them. For example, a source in the selected set may be the SES 105 that stores and maintains the data files of an enterprise application. If any source not included in the selected set sends data files to the SCN 104, those data files may be stored in the memory 403. However, the DFL does not include entries for those data files. The data files in the memory 403 are maintained by an SCN Cache Module (CM) 402. The caching of data files and the deletion of data files from the memory 403 is done by the SCN CM 402. An SCN Dedicated Module (DM) 401 maintains a list of data files cached in the memory 403. The list is maintained as a DFL. Each entry in the DFL includes at least a unique identifier and a size measure for a respective data file cached in the memory 403. If the SCN 104 receives new data files from the SES 105, the SCN DM 401 updates the DFL and sends a notification to every CCN 102 instance indicating the availability of a new version of the DFL. If a CCN 102 requests the latest version of the DFL, the SCN DM 401 sends the latest version of the DFL to the CCN 102. If the used storage space in the memory 403 is above a pre-determined level, then the SCN DM 401 arranges for the removal of some data files from the memory 403 in order to bring the used storage space in the memory 403 below the pre-determined storage threshold. For example, the SCN DM 401 may request the deletion of data files obtained from unsupported sources. After deleting data files and bringing the used storage space below the pre-determined storage threshold, the SCN DM 401 updates the DFL. If the SCN 104 receives any data files from a supported source, the SCN DM 401 includes an entry for the received data files in the DFL. Data files remain stored in the SCN 104 for a pre-determined duration of time. If there is any data file that has been cached in the memory 403 for a period of time longer than the pre-determined duration of time, then the SCN DM 401 disposes for the removal of the data file from the memory 403. A processor 404 controls the operation of the SCN 104.

If there are instances of CCN 102 that may be in sleep state, the SCN 104 may retrieve the list of CCN 102 instances that are in the sleep state. When the SCN 104 receives new data files from the SES 105 to be sent to the CES 101 instances and a new version of the DFL has been created in the SCN 104, the SCN 104 sends messages to the CCN 102 instances that are in sleep state to bring to the operational state the CCN 102 instances that are in sleep state.

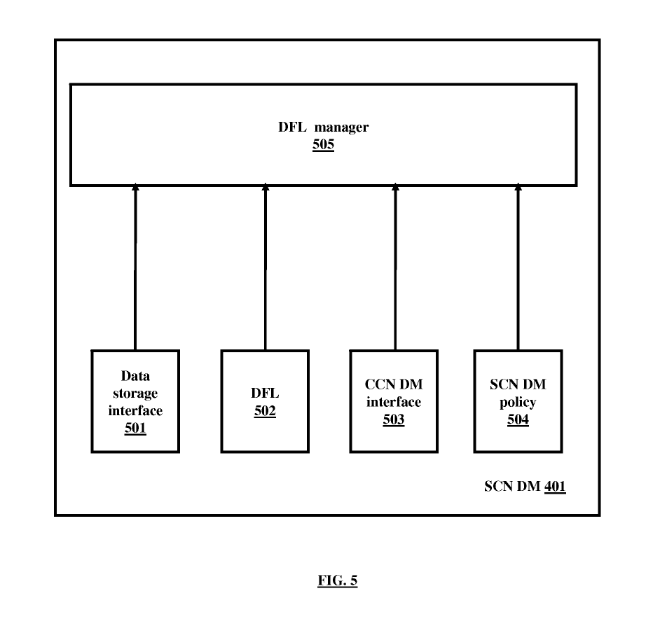

FIG. 5 illustrates a server cache node dedicated module (SCN DM). An SCN DM 401 maintains a list of the data files cached in the memory 403 of the SCN 104. The list is maintained as a DFL 502. The DFL 502 includes entries with information about the data stored in the memory 403. Each entry in the DFL 502 includes at least a unique identifier and a size measure for a corresponding data file cached in the memory 403. If the SCN 104 receives new data files from the SES 105, the SCN DM 401 updates the DFL 502 and sends notifications to the CCN 102 instances indicating the availability of a new version of the DFL 502. The notifications are sent to the CCN 102 instances using a CCN DM interface 503. If a CCN 102 requests the latest version of the DFL 502 from the SCN 104, the SCN DM 401 sends the latest version of the DFL 502 to the CCN 102 through the CCN DM interface 503. If the CCN 102 requests a data file, the SCN DM 401 sends the data file to the CCN 102 through the CCN DM interface 503. If the used storage space in the memory 403 is above a pre-determined storage threshold, then the SCN DM 401 arranges for the removal of some data files from the memory 403 in order to bring the used storage space in the memory 403 below the pre-determined storage threshold. A data storage interface 501 interfaces with the memory 403 and obtains information about the current memory usage. If any data files have to be deleted from the memory 403, the data storage interface 501 removes the data files from the memory 403. After deleting data files and bringing the used storage space below the pre-determined storage threshold, the SCN DM 401 updates the DFL 502.

Only data files that are received from a selected set of sources are entered in the DFL 502. The SCN 104 maintains in an SCN DM policy 504 a list of supported sources such that data files that originate from them may have associated entries in the DFL 502. If any source not included in the SCN DM policy 504 sends data files to the SCN 104, those data files may be stored in the memory 403. However, no entry is added to the DFL 502 for those data files. If the SCN 104 receives data files from a source listed in the SCN DM policy 504, then the SCN DM 401 adds entries for those data files to the DFL 502. A Data File List Manager (DFLM) 505 maintains the DFL 502 based on information received from the data storage interface 501 and contained in the SCN DM policy 504. Data files are stored in the SCN 104 for a pre-determined duration of time. If there is any data file that has been cached in the memory 403 for a period of time longer than the pre-determined duration of time, then the SCN DM 401 removes the data file from the memory 403 through the data storage interface 501.

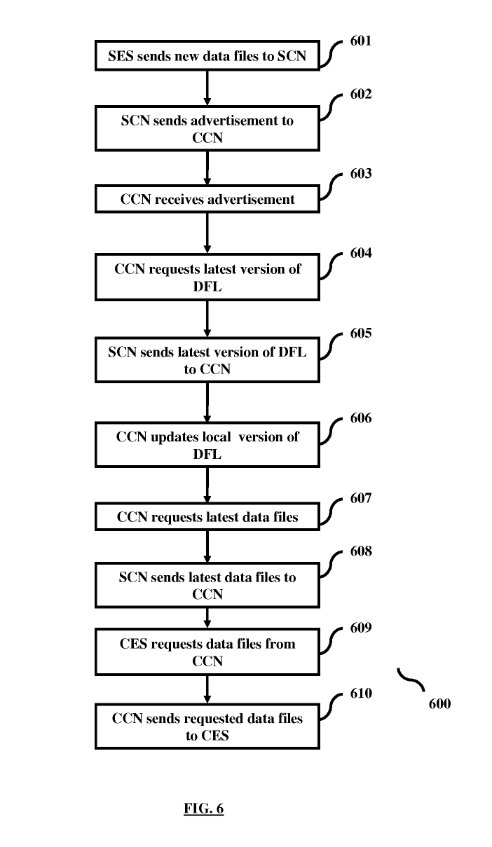

FIG. 6 is a flowchart depicting a method for sending latest data files from an SES 105 to one of the CES 101 instances. A CES 101 in a network initiates a data file transfer session with the SES 105. The session may be initiated for communicating with the server or to request a data file from the SES 105. The SES 105 stores data files that can be retrieved by the CES 101 at any point in time. For example, an employee of an organization may request a data file from an enterprise server of the organization from a remote location. If the SCN 104 forwards to the SES 105 a request for new data files from a CES 101 instance, then the SES 105 sends (601) the data files to the SCN 104. If the data files received by the SCN 104 are from supported sources listed in the SCN DM policy 504, the SCN DM 401 updates the DFL 502 and sends (602) a notification to the CCN 102 indicating the availability of the latest version of the DFL 502. On receiving (603) the notification, the CCN 102 requests (604) the SCN 104 for the latest version of the DFL 502. The SCN responds to the request by sending (605) the latest version of the DFL 502 to the CCN 102 through the SNS. On receiving the latest version of the DFL 502, if there are new entries listed in the DFL, the CCN 102 updates (606) the local version of the DFL 302 using the received latest version of the DFL 502. If the updated DFL 302 indicates that there are new data files in the SCN 104, the CCN 102 requests (607) the new data files. The SCN 104 responds to the request by sending (608) the new data files to the CCN 102. If, at a later point in time, the CES 101 requests (609) a data file stored in the CCN, the CCN 102 sends (610) the requested data file to the CES 101. After any data files have been sent from the CCN 102 to the CES 101, the CCN DM 201 arranges for the deletion of the data files from the memory 203. After the data files have been deleted, the CCN DM 201 marks the entry for the data files in the DFL 302 as “delivered”. The various actions in method 600 may be performed in the order presented, in a different order or simultaneously. Further, in some embodiments, some actions listed in FIG. 6 may be omitted.

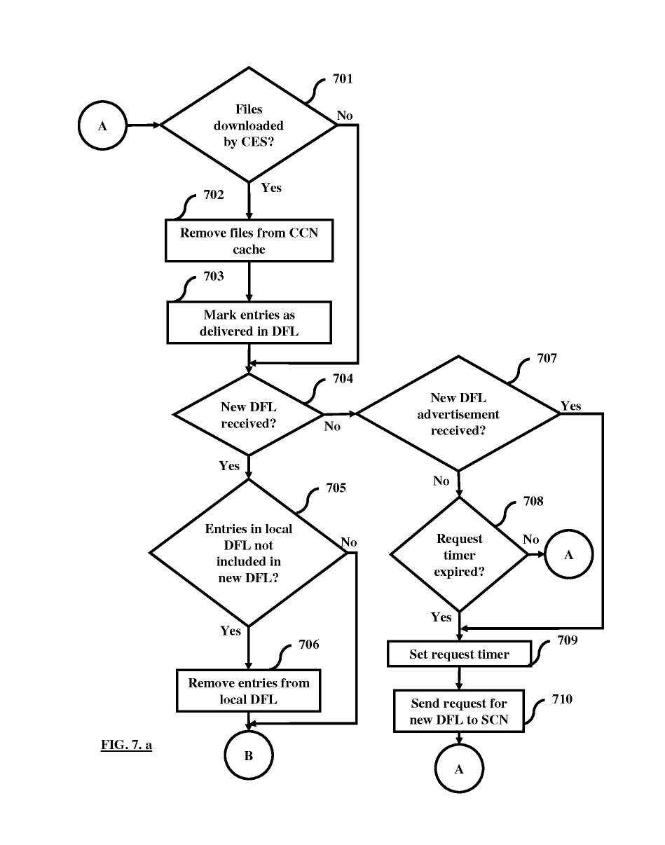

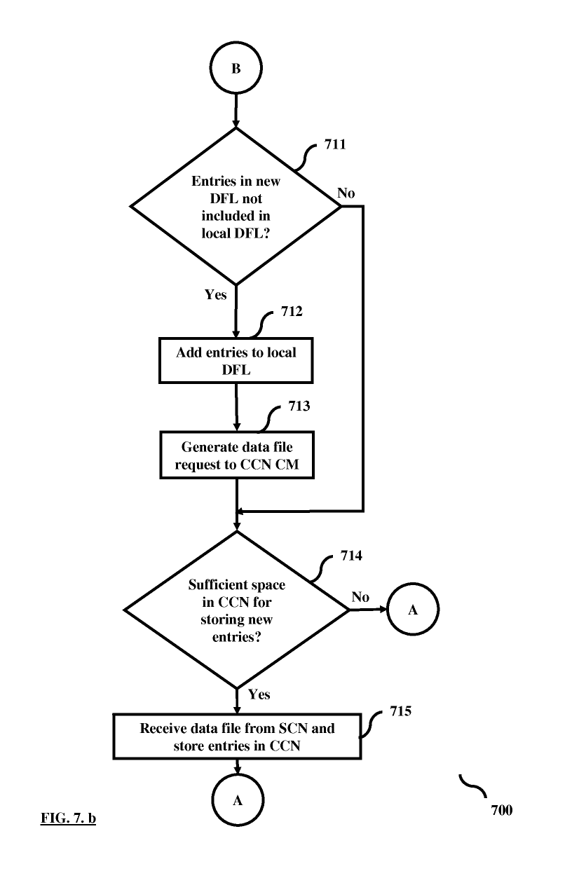

FIGS. 7a and 7b are a flowchart depicting a method of operation of a client cache node. A CCN 102 is a network cache node included in the network path between the CES 101 and the SNS. The CCN 102 remains in operational state independently of the availability state of the CES 101 and of the SNS. The CCN 102 establishes connectivity with the SCN 104 when the SNS is available and independently of the availability state of the CES 101. The CCN 102 maintains connectivity with the CES 101 as long as the CES 101 remains available and independently of the availability state of the SNS. The DFLM 306 maintains the DFL 302 based on information received from the data storage interface 301 and from the SCN DM interface 303. The DFLM 306 verifies (701) with the data storage interface 301 if the memory 203 has any data files that have been already downloaded by the CES 101. If there are files in the memory 203 that have been downloaded by the CES 101, then the DFLM 306 instructs the data storage interface 301 to delete (702) the files from the memory 203. Then the DFLM 306 marks (703) the entries in the DFL 302 as “delivered” for the deleted files. If there are no files in the memory 203 that have been downloaded by the CES 101, then the DFLM 306 verifies with the SCN DM interface 303 if a new version of the DFL 502 has been received (704) from the SCN 104. If a new version of the data files list has not been received, then the DFLM 306 verifies (707) with the SCN DM interface 303 if a new DFL notification has been received. If a new DFL notification has not been received by the SCN DM interface 303, the DFLM 306 checks (708) to determine if the request timer 305 has expired. The request timer 305 helps in keeping track of the time elapsed since the generation of the last request to the SCN 104 for the DFL 502. The DFLM 306 sets (709) the request timer 305, then the DFLM 306 instructs the SCN DM interface 303 to send (710) a request to the SCN 104 for the latest version of the DFL 502.

If a new version of the DFL 502 has been received, the DFLM 306 checks to determine (705) if there are any entries in the DFL 302 that are not included in the new version of the DFL 502 received from the SCN 104. If there are any entries in the DFL 302 that are not included in the new version of the DFL 502 received from the SCN 104, then the DFLM 306 removes (706) those entries from the DFL 302. The DFLM 306 then checks (711) to determine if there are any entries in the latest version of the DFL 502 received from the SCN 104 that are not included in the local version of the DFL 302. If there are any entries in the latest version of the DFL 502 received from the SCN 104 that are not included in the local version of the DFL 302, then the DFLM 306 adds (712) the new entries to the DFL 302. The DFLM 306 instructs the CCN DM interface 503 to generate (713) a request to the CCN CM 202 for the data files corresponding to the new entries added to the DFL 302. Then the DFLM 306 verifies (714) with the data storage interface 301 if there is sufficient memory 203 to accommodate the new data files. If the memory space is not sufficient to accommodate the new data files, then the DFLM 306 communicates to the data storage interface 301 the need for deleting some data files from the memory 203. The data storage interface 301 instructs the CCN DM 201 to identify and remove data files from the memory 203. If there is sufficient space to accommodate the new data files, then the data files received from the SCN 104 are stored in the memory 203. The various actions in method 700 may be performed in the order presented, in a different order or simultaneously. Further, in some embodiments, some actions listed in FIG. 7 may be omitted.

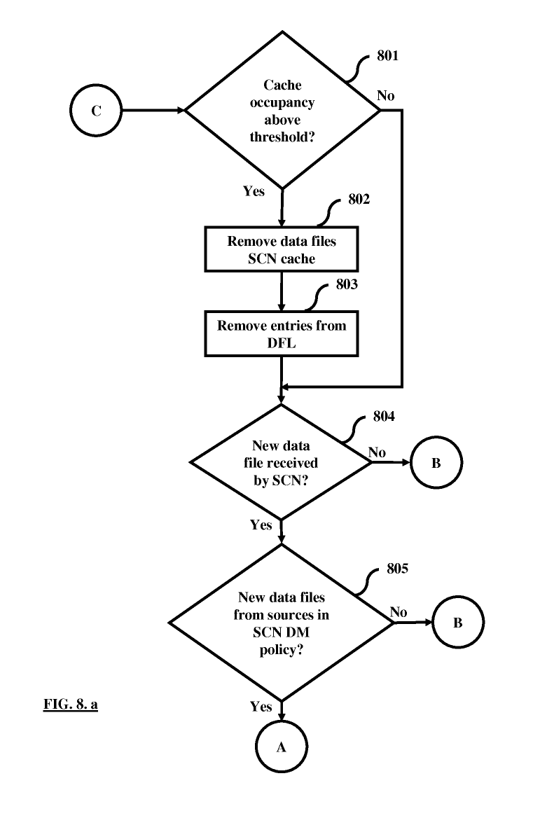

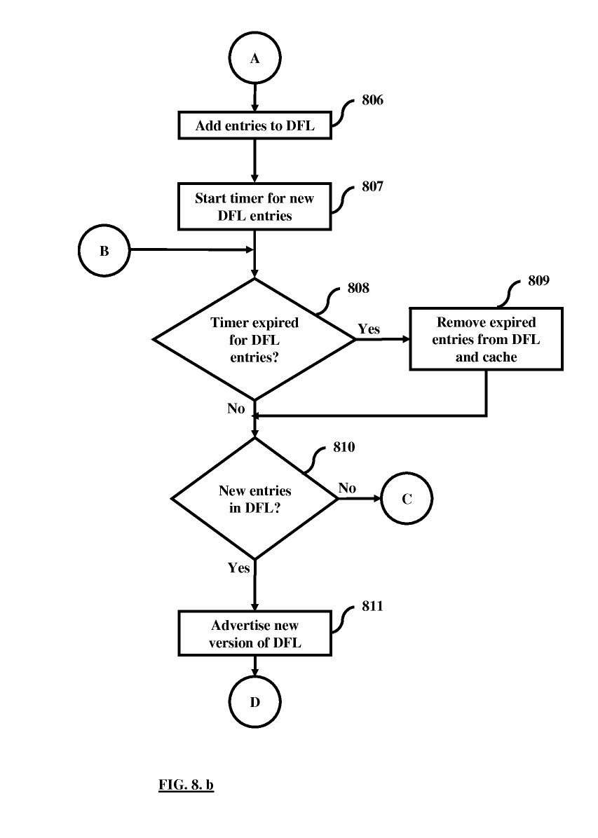

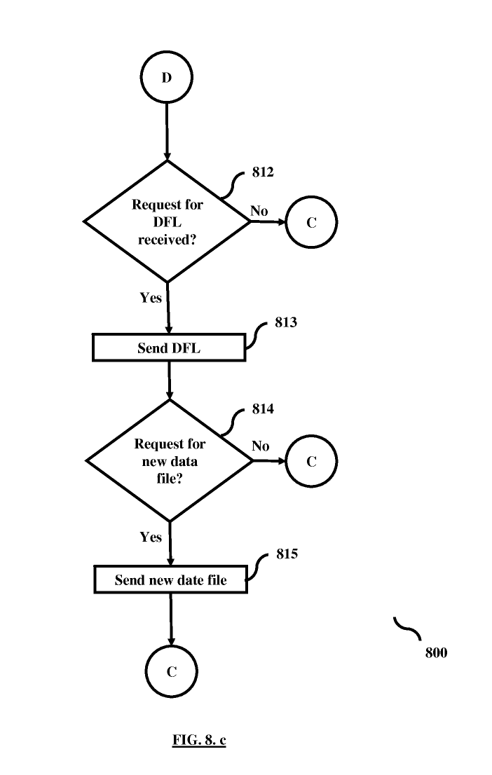

FIGS. 8a, 8b and 8c are flowcharts depicting a method of operation of a server cache node. There is no overlap between the SNS and the network path between the SES 105 and the SCN 104. The SCN 104 is operational with high availability and has persistent network connectivity with the SES 105. The SCN 104 is included in the network paths between the SES 105 and the CES 101 instances connected to the SES 105. The SCN 104 obtains data files from the SES 105, stores the obtained data files and sends the data files to the CES 101 instances through the CCN 102 instances and the respective SNS instances. If the CES 101 wants to send some data files to the SES 105, the SCN 104 obtains the data files, stores the obtained data files and transmits the data files to the SES 105. If the used storage space in the memory 403 is above (801) a pre-determined storage threshold, then the SCN DM 401 arranges for the removal (802) of some data files from the memory 403 in order to bring the used storage space in the memory 403 below the pre-determined storage threshold. A data storage interface 501 interfaces with the memory 403 and obtains information about the current memory usage. If any data files have to be deleted from the memory 403, the data storage interface 501 removes the data files from the memory 403. After deleting the data files and bringing the used storage space below the pre-determined storage threshold, the SCN DSN 401 updates the DFL 502 and removes (803) the entries corresponding to the deleted files from the DFL 502. The DFLM 505 verifies with the data storage interface 501 to determine (804) if new data files have been stored in the memory 403. If new data files have been received by the SCN 104, then the DFLM 505 verifies (805) if the data files were received from sources listed in the SCN DM policy 504. If the data file was received from a source listed in the SCN DM policy 504, the DFLM 505 updates the DFL 502 by adding (806) entries to the DFL 502 corresponding to each new data file received. The DFLM 505 starts (807) a timer for each new entry added to the DFL 502. The DFLM 505 then checks to determine (808) if the timer has expired for any of the entries in the DFL 502. If the timer has expired for any of the entries in the DFL 502, then the DFLM 505 removes (809) the entries from the DFL 502 and instructs the data storage interface 501 to delete the corresponding data files from the memory 403.

The DFLM 505 checks to determine (810) if any new entry has been added to the DFL 502. If a new entry has been added to the DFL 502, then the DFLM requests the CCN DM interface 503 to send (811) a notification to the CCN 102, indicating the addition of a new entry to the DFL 502. On receiving the notification, the CCN 102 may request the latest version of the DFL 502 from the SCN 104. The DFLM 505 verifies (812) with the CCN DM interface 503 if a request has been received from the CCN 102. If a request was received from the CCN 102, the DFLM 505 instructs the CCN DM interface to send (813) the latest version of the DFL 502 to the requesting CCN 102. On receiving the latest version of the DFL 502 from the SCN 104, the DFLM 306 in the CCN 102 checks to determine if there are any entries in the latest version of DFL 502 received from the SCN 104 that are not included in the local version of the DFL 302. If there are any entries in the latest version of the DFL 502 received from the SCN 104 that are not included in the local version of the DFL 302, then the CCN 102 sends a request to the SCN 104, requesting the data files corresponding to the new entries added to the DFL 302. On receiving (814) the request from the CCN 102, the SCN 104 sends (815) the requested data files to the CCN 102. The various actions in method 800 may be performed in the order presented, in a different order or simultaneously. Further, in some embodiments, some actions listed in FIG. 8 may be omitted.

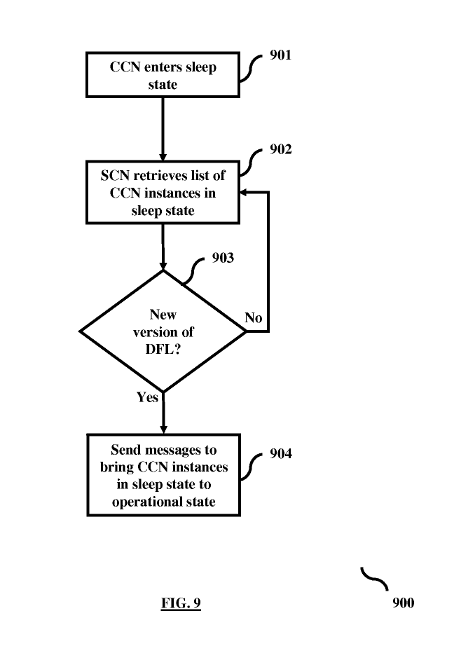

FIG. 9 is a flowchart depicting a method for bringing a client cache node to operational state from a sleep state. The CCN 102 enters (901) a low-power sleep state when the CES 101 has been not available for a pre-determined period of time and the CCN 102 has been idle for a pre-determined period of time. If there are CCN 102 instances in sleep state, the SCN 104 retrieves (902) the list of CCN 102 instances in the sleep state. If the SCN 104 has (903) a new version of the DFL 502 to be sent to the CCN 102, the SCN 104 sends (904) a message to each CCN 102 in sleep state to bring the CCN 102 to the operational state. The various actions in method 900 may be performed in the order presented, in a different order or simultaneously. Further, in some embodiments, some actions listed in FIG. 9 may be omitted.

Embodiments described allow the transfer of data files between the source and destination systems without the requirement to have both the NPI and CESA simultaneously satisfied. Security updates can be can be completed quickly, dramatically reducing the reaction time of an organization to new security threats, especially when many employees in the organization are equipped with mobile laptops.

The embodiments disclosed herein can be implemented through at least one software program running on at least one hardware device and performing network management functions to control the network elements. The network elements shown in FIG. 1, FIG. 2, FIG. 3, FIG. 4 and FIG. 5 include blocks which can be at least one of a hardware device, or a combination of one or more hardware devices and one or more software modules.

The embodiment disclosed herein specifies a method and system for expediting the transfer of data files between an SES and a plurality of CES instances. The mechanism allows transferring data files between network cache nodes providing a system thereof. Therefore, it is understood that the scope of the protection is extended to such a program and in addition to a computer-readable means having a message therein, such computer readable storage means containing program code means for implementation of one or more steps of the method, when the program runs on a server or mobile device or any suitable programmable device. The method is implemented in a preferred embodiment through or together with a code written in e.g. Very high speed integrated circuit Hardware Description Language (VHDL) or another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, or at least one microprocessor and at least one memory with software modules located therein. The method embodiments described herein could be implemented in pure hardware or partly in hardware and partly in software. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for expediting the transfer of data files between a Server End System (SES) and a plurality of Client End Systems (CES), said method comprising steps of
a Server Cache Node (SCN) connected to said SES transferring data files from said SES;
said SCN sending selected information identifying data files cached in said SCN to a plurality of Client Cache Nodes (CCNs), wherein each of said plurality of CCNs is connected to each of said plurality of CES;
at least one of said CCNs sending a request to said SCN for data files cached in said SCN, based on a comparison between information identifying data files cached in said CCN with said selected information;
said SCN sending said requested data files to said CCN; and
said CCN transferring said data files from said CCN to said CES.

2. The method, as claimed in claim 1, wherein said CCN is connected to said SCN through a Sporadic Network Segment (SNS).

3. The method, as claimed in claim 1, wherein said SCN is in operational state independently of the availability state of said SES or said SNS.

4. The method, as claimed in claim 1, wherein each CCN of said plurality of CCNs is in operational state independently of the availability state of said CES connected to said each CCN or said SNS.

5. The method, as claimed in claim 1, wherein said method further comprises steps of
each of said plurality of CCNs maintaining a list of data files cached in said SCN; and
each of said plurality of CCNs requesting a latest version of said list from said SCN at pre-determined intervals of time.

6. The method, as claimed in claim 1, wherein said SCN is connected to said SES by one of
a Universal Serial Bus (USB) connection;
a Personal Computer Memory Card International Association (PCMCIA) connection;
an ExpressCard connection; or
a network path.

7. The method, as claimed in claim 1, wherein said CCN is connected to said CES by one of
a Universal Serial Bus (USB) connection;
a Personal Computer Memory Card International Association (PCMCIA) connection;
an ExpressCard connection; or
a network path.

8. The method, as claimed in claim 1, wherein each of said plurality of CCNs further perform steps of
storing said data files if said CES to which said CCN is connected is not available; and
transferring said data files to said CES, when said CES requests said data files.

9. A Server Cache Node (SCN) for expediting the transfer of data files between a Server End System (SES) and a plurality of Client End Systems (CES), said SCN comprising at least one means adapted for
caching data files received from said SES, wherein said data files are made available to at least one of said CESs;
sending a notification, at pre-determined intervals of time, to a plurality of Client Cache Nodes (CCNs), wherein said notification indicates the presence of new data files cached in said SCN;
sending information identifying data files cached in said SCN to said CCN on receiving a request for said information from said CCN; and
sending data files to said CCN on receiving a request for said data files from said CCN.

10. The SCN, as claimed in claim 9, wherein said SCN is adapted to maintain said information , wherein said information is updated when new data files are cached in said SCN.

11. The SCN, as claimed in claim 9, wherein said SCN is adapted to
retrieve information concerning said CCN instances in a sleep state; and
send a message to said CCN instances in said sleep state to bring said CCN instances in said sleep state to operational state.

12. The SCN, as claimed in claim 9, wherein said SCN is adapted to cache said data files in a data storage means.

13. The SCN, as claimed in claim 9, wherein said SCN is adapted to connect to said SES by one of
a Universal Serial Bus (USB) connection;
a Personal Computer Memory Card International Association (PCMCIA) connection;
an ExpressCard connection; or
a network path.

14. The SCN, as claimed in claim 9, wherein said SCN is adapted to be in operational state independently of the availability state of said SES or said SNS.

15. A Client Cache Node (CCN) for expediting the transfer of data files between a Server End System (SES) and a Client End System (CES), said CCN comprising at least one means adapted for
sending a request on a pre-determined schedule to a Server Cache Node (SCN) requesting latest information identifying data files cached therein;
receiving said information from said SCN;
sending a request to said SCN for selected data files cached in said SCN, based on said information; and
said CCN transferring said selected data files to said CES upon receiving requests for said selected data files from said CES.

16. The CCN, as claimed in claim 15, wherein said CCN is adapted to be in operational state independently of the availability state of said CES or said SNS.

17. The CCN, as claimed in claim 15, wherein said CCN is adapted to maintain information identifying data files cached in said CCN, wherein said information is updated when new data files are cached in said CCN.

18. The CCN, as claimed in claim 15, wherein said CCN is adapted to send said request to said SCN by comparing said information identifying data files cached in said SCN with said information identifying data files cached in said CCN.

19. The CCN, as claimed in claim 15, wherein said CCN is adapted to cache said data files in a data storage means.

20. The CCN, as claimed in claim 15, wherein said CCN is adapted to enter a low-power sleep state when said CCN has been idle for a pre-determined period of time and come back to operational state on receiving a message from said SCN.

21. The CCN, as claimed in claim 15, wherein said CCN is adapted to connect to said CES by one of
a Universal Serial Bus (USB) connection;
a Personal Computer Memory Card International Association (PCMCIA) connection;
an ExpressCard connection; or
a network path.

22. The CCN, as claimed in claim 15, wherein said CCN is adapted to check for availability of said CES to which said CCN is connected, before transferring said data files to said CES.

23. The CCN, as claimed in claim 15, wherein said CCN further comprises at least one means adapted for
storing said data files if said CES is not available; and
transferring said data files to said CES, when said CES requests them.
